(19) United States
(12) Patent Application Publication
(10) Pub. No.: US 2009/0066631 A1
(43) Pub. Date: Mar. 12, 2009

(54) BACKLIGHT CONTROL SYSTEM AND METHOD USING DITHER SAMPLING

(75) Inventor: Thomas A. Lianza, Bedford, NH (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: X-RITE, INC., Grand Rapids, MI (US)

(21) Appl. No.: 11/854,085

(22) Filed: Sep. 12, 2007

(51) Int. Cl. G09G 3/36

(52) U.S. Cl. 345/102

(57) ABSTRACT

A controller device provides for local and global control of illumination color and intensity of a backlight. The controller architecture allows for optimization of an illumination surface and simultaneous sensing, analysis and control of each supported region of the surface to enable uniform light and color luminance output from the surface. The controller utilizes a temporal feedback mechanism which allows the use of monochrome sensors to control the color luminance output of the illumination system. The controller can be used during production of displays to set initial optimal conditions and also to continuously monitor and adjust backlighting during use of the display by the consumer. By using high frequency monitoring and control signals, as well as color blending, testing and correction can be conducted during use and beyond the threshold of perception of the human observer.

### FIELD OF THE INVENTION

The present invention relates to electronic displays and more particularly to back-lit Liquid Crystal Displays (LCDs) illuminated by LED backlights and controllers for same.

### BACKGROUND OF THE INVENTION

Electronic display screens are widely used in a variety of consumer and industrial applications such as televisions, computer monitors and instrument panels, etc. Currently, an array of optical shutters and a backlight system that beam light on the display screen are widely used in flat panel display screens, such as Liquid Crystal Displays (LCDs).

A number of lighting methods are currently used for the backlight systems. For example, fluorescent cold cathode tubes and an array of light-emitting diodes (LEDs) can be used, most frequently, positioned behind the LCD panels.

The design of LED backlight controllers traditionally relies upon a large array of LEDs or multiple LED modules that are used to provide the illumination for the display. The use of many emitters often necessitates the need to sort or “bin” emitter devices based upon physical properties such as color and efficiency. While sorting may provide the solution for providing a constant luminance over a fixed area, the coupling mechanism to the display may introduce further distortions to the luminance uniformity due to diffuser variance or transmission variance of the panel.

The Avago HDD-822A is demonstrative of a typical backlight controller architecture. This product features tree channels of light detection (XYZ) and three channels of Pulse Width modulated luminance output. This architecture utilizes a color sensor to detect the RGB luminance output of the RGB LEDs, a computing element to calculate a correction to be loaded into the PWM controller, and three PWM controllers to luminance output the control signals to the RGB LEDs.

Conventionally, a red-green-blue (RGB) color sensor is also used to continuously sample the luminance output of the RGB luminance output signal as part of the feedback to the backlight controller. While this method is intuitively obvious it has a number of pitfalls. These problems include: 1) The RGB sensor is relatively expensive and usage in large numbers results in elevated cost; 2) The RGB sensor requires three A/D converters or a multiplexer, which increases operational complexity and manufacturing cost; 3) The RGB sensor is an element that can drift with age due to light levels on the sensor. 4) The RGB sensor has relatively wide band filters which lead to interactions with the RGB emitters. This means that changes in the luminance output of a single emitter are sensed by more than a single color photo sensor. This introduces a requirement of matrix multiplication to deduce the change in the single emitter luminance output. In addition, complicating the task of maintaining a given color intensity. It therefore remains an objective to render improved LED backlight apparatus and methods.

### SUMMARY OF THE INVENTION

The present invention includes a backlight control system and method for electronic displays that provides optimization of color and/or intensity of light emitting elements of the display panel. In one embodiment, an electronic display with a backlight control system has a display panel and a backlight panel having a plurality of light emitting elements, at least one monochromatic sensor and a colorimetric processing engine. The colorimetric processing engine provides optimization in controlling the backlight panel by utilizing dither sampling of feedback from the at least one monochromatic sensor. In an embodiment of the present invention, control may be exerted over regions of the illuminated display panel of any given size to enable uniform light and color luminance output of the display, using temporal dither sampling and feed back. In an embodiment of the invention, a monochromatic sensor(s) may be employed to sense on and thereby to control the color luminance output of a plurality of light emitters having different color luminance output. An embodiment of the present invention may simultaneously control multiple regions, correlate the luminance output of such regions, and utilize a temporal sampling scheme to allow for the utilization of fewer sensors and monochrome sensors, rather than multi-color sensors. In accordance with an embodiment of the invention, the usage of temporal sampling and sensing allows for a predictive control loop which minimizes servo overshoot. In accordance with embodiments of the invention, sampling frequency may be selected to exceed the threshold of human perception and color blending may be used to mask sampling activity.

### BRIEF DESCRIPTION OF THE DRAWINGS

FIG. 1 is a schematic view of an electronic display with backlight and backlight control system in accordance with an embodiment of the present invention.

FIG. 2 is a schematic diagram of a portion or region of the backlight of FIG. 1.

FIG. 3 is a module diagram of a backlight control system in accordance with an embodiment of the present invention.

FIG. 4 is a diagram showing the step-by-step procedure of the dither sampling measuring method; FIG. 5 is a schematic view of a colorimetric data collection system (CDCS) used in a factory calibration process.

FIG. 6 is a flow chart of a method for conducting calibration in accordance with an embodiment of the present invention.

FIG. 7 is a flow chart showing a Base Gain Determination method in accordance with an embodiment of the present invention.

FIG. 8 is a flow chart showing an Active Calibration Process in accordance with an embodiment of the present invention.

FIG. 9 is a graphic illustration of selection of gain parameters for a dither process.

### DETAILED DESCRIPTION

The devices, systems and methods disclosed herein may facilitate the design and manufacturing of individual backlight control system in accordance with exemplary embodiments of the present invention and may be adapted to any electronic display with backlight control systems. The devices, systems and methods disclosed herein can be implemented to maintain control over an array of color producing elements, such as light emitting diodes and may further provide a method of using monochrome instead of RGB backlight sensors and reduce the number of sensors in achieving backlight control for any electronic display with backlight system used, such as LCDs.

The present invention provides a backlight control system and method that provides one or multi-region control of illumination color and intensity which allows the optimization of an illumination surface and simultaneous sensing, analysis and control of each controlled region of the illuminated surface to enable uniform light and color luminance output of the surface.

Another aspect of the present invention is the utilization of a temporal feed back mechanism which allows the use of monochrome sensors to control the color luminance output of the illumination system, replacing the application and use of RGB sensors, and therefore to decrease manufacturing cost, improve product service life and quality.

The disclosed devices, systems, and method may advantageously be implemented by using temporal dither sampling of the display panel. Further, the disclosed devices, systems, and methods may enable a designer and manufactures to reduce production costs, and provide prolonged product service life.

For purposes of the present disclosure, the terms “optical analog sensor module”, “multiplexer A/D module”, “colorimetric processing engine” and “pulse width modulation module” may be implemented by any data micro processors and/or computing chips of any integrated or discrete type. Further, these data micro processors and/or computing chips might be in communication in many forms of data transmission. Likewise, ‘optical sensor’ may encompass any type of sensor of that kind, which provides similar capacity and functionality as that disclosed in the present invention. Thus, for example, an optical sensor might be a PIN photodiode sensor.

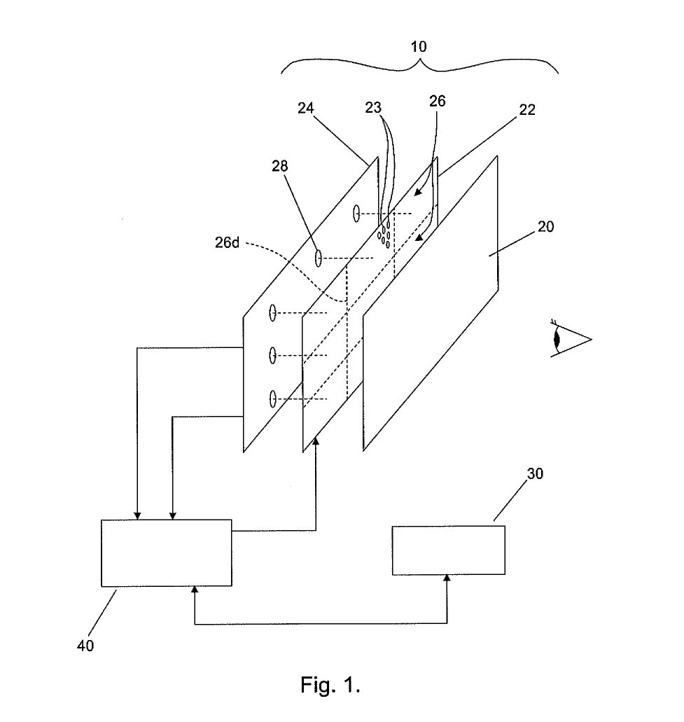

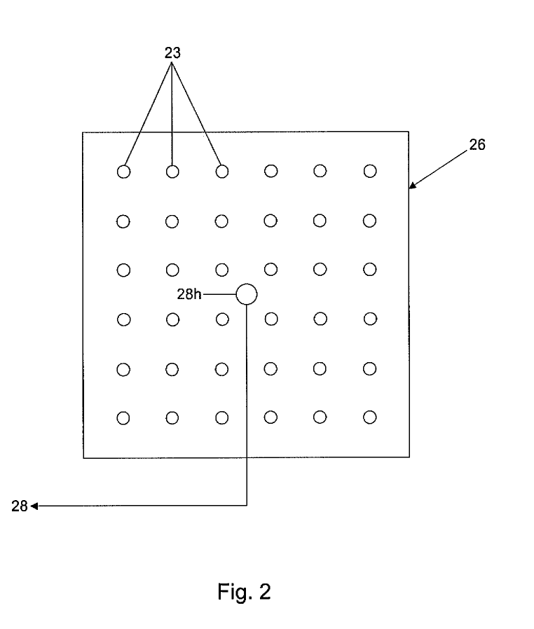

An exemplary embodiment of the presently disclosed invention is illustrated and described relative to FIGS. 1 and 2, which are schematic views of an electronic display 10 with a backlight and backlight control system in accordance with an embodiment of the present invention. The LCD panel 20 is illuminated by a backlight 22 that is made up of multiple regions 26 as delineated by dashed lines 26d on the backlight panel. Each region 26 has an optical sensor 28, mounted proximate thereto on sensor panel 24. A single optical sensor 28 may serve a plurality of light emitting elements 23 (only a few are diagrammatically depicted in FIG. 1 for ease of illustration) in a region 26 of a selected size. FIG. 2 shows a typical region 26 with emitters 23 and sensor head 28h, which connects to the sensor unit 28.

The luminance output of sensors 28 is received as inputs by the backlight controller module 40 (FIG. 1). The backlight controller module 40 is controlled by commands from the main LCD controller 30 (FIG. 1).

The division of the backlight 22 into regions 26 facilitates wiring connections and may be used to assign a given plurality of light emitting elements 23 to a sensor unit 28.

### Modular Description of Exemplary Backlight Control System

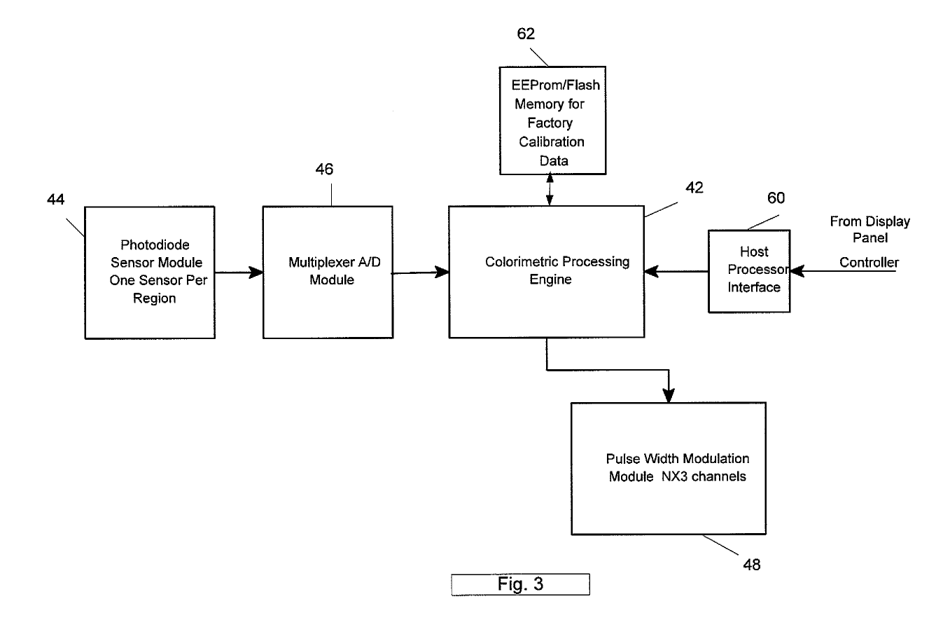

FIG. 3 shows a module diagram of the presently disclosed backlight control system. The controller utilizes one third the number of sensors for any number of color channels. Each color channel drives a Red, Green and Blue emitter module. The present invention anticipates and encompasses the use of other colors as well.

In FIG. 3, the colorimetric processing engine 42 is a microcontroller module that accepts inputs from the optical analog sensing (photodiode) module 44 through the multiplexer A/D module (46) and along with factory calibration data from an EPROM/Flash memory 62 and it computes the values to be loaded into each pulse width modulation (PWM) channel 48. The number of PWM channels 48 is based upon the number of regions 26. For instance, if twelve regions of R,G,B emitters are being controlled, there will be thirty-six PWM luminance output channels. The current design is completely programmable so one might choose to use four colors of emitters over nine regions which would still require thirty-six PWM channels. This invention is not limited to any number of specific regions or color luminance output channels. The fundamental limitations are based upon cost and physical size of the backlight controller.

The colorimetric processing engine 42 implements the methods of the backlight control algorithm of the present invention. In practice, this can be implemented in a physical ASIC or it may be implemented as a numerical controller such as a PIC or ARM processor. The advantage of using a standard RISC processor architecture is speed and flexibility. The implementation of the colorimetric processing engine 42 in a logical element in an ASIC may promote economies of scale. The colorimetric processing engine 42 may contain flash memory 62 for program and calibration data. An additional EEPROM maybe used to contain additional calibration data and other manufacturing data such as serial number and date of manufacture.

The optical analog (photodiode) sensing module 44 is used to interface external sensor unit 28 to the colorimetric processing engine 42. This module integrally or separately includes either a multiplexer or a number of parallel A/D converters 46. The actual processing does not require simultaneous capture of multiple input signals, so parallelism is not a requirement. FIG. 1 also shows that there maybe one optical sensor 28 for each region 26. The A/D converter 46 must be capable of handling 12 bit conversions at rate greater than 480 conversions per second. The need for this rate is predicated on the need to vary the light levels and measure the response faster than the period the eye can resolve a change in signal.

The pulse width modulation module 48 contains the physical pulse width modulation luminance output channels. Pulse width modulation and apparatus for conducting same are well-known in the art. PWM channels for the present invention allow for physical changes in light luminance output at resolutions greater than 10 bits. As stated above, there is a PWM channel for each color in each region 26 so the physical number of channels for each region 26 is equal to the number of colors in that region.

The host processor interface 60 used in this system is the I2C interface. For the present disclosure, the term “host” is used to describe the master controller for the display as opposed to a primary computer used by an end user. This is a standard synchronous interface between peripheral functions on a display or TV host controller known to those skilled in the art. During factory calibration, calibration data is measured externally and loaded down to the colorimetric processing engine 42.

External calibration data module 62 feeds the colorimetric processing engine 42 with externally calibrated data. The backlight control system is designed to maintain and control the luminance output of an array of regions 26 and color emitters within a given region. The luminance of region/emitter combinations must be measured and this data stored in a non-volatile memory element The full scale luminance output of each colored emitter in each region 26 is measured and stored as a CIE XYZ Tristimulus Value, known to those skilled in the art. This implies that there must be storage for (3×m×n) calibration values, where m is the number of different color emitters in a region and n represents the total number of regions 26. For a 12-region display with 3 colored emitters, the minimum number of stored measured values would be 3×3×12=108 values. For 16 bit data scaling, this represents 216 bytes of calibration data.

### Dither Sampling Measuring Method and Temporal Dither Sampling Measuring Method

The present invention utilizes a novel technique for deducing changes in luminance output RGB signal level S₀ by utilizing a single optical sensor (e.g., photodiode). This can be illustrated mathematically.

S₀=S(g, R)+S(g_{g}G)+S(g_{b}B) Equ. 1

Let the signal on the monochrome sensor be the sum of the luminance output signals of the R, G, and B emitters. The “g” terms are settable gains that are used to set the level of the individual components. One method of measuring the signal level attributable to a single RGB component is to turn off the other two, measure and then perform the same action for the other two components. The problem with this method is that there will probably be a noticeable “flash” on the screen as the measurement is occurring. This would not be a problem during the power up cycle because the LCD could be set to maximum attenuation and the “blink” would not be noticeable. Naturally, during normal viewing, this “blink” might be annoying. If a display was set to full white and this operation was performed for an extremely short duration, the apparent blink would be minimized or it might even disappear. The problem is that the required minimum period can be viewer dependent. This problem occurs because of the human eye's natural ability to distinguish rapid changes of large extent, even if they are for extremely short periods. As the flash duration gets shorter, the apparent intensity of the flash seems to diminish. We can model the signal luminance output of a temporally sampled optical sensor using the equation set in Equ 2:

S₁=k₁\hat{R}+k₂Ĝ+k₃\hat{B}

S₂=k₄\hat{R}+k₅Ĝ+k₆\hat{B}

S₃=k₇\hat{R}+k₈Ĝ+k₉\hat{B} Equ. Set 2

This set of equations illustrates the mathematics of changing the gain in each of the optical output levels simultaneously and measuring the luminance output on a single detector. By varying the gain in a known fashion, simultaneously we can deduce the physical luminance output of the light by measuring the three signals independently in time. We solve for \hat{R}, Ĝ, \hat{B} using the following relationship:

$$[ \begin{matrix}\hat{R} \\ \hat{G} \\ \hat{B}\end{matrix} ] = [ \begin{matrix}{k}_{1} & {k}_{2} & {k}_{3} \\ {k}_{4} & {k}_{5} & {k}_{6} \\ {k}_{7} & {k}_{8} & {k}_{9}\end{matrix} ] * [ \begin{matrix}{S}_{1} \\ {S}_{2} \\ {S}_{3}\end{matrix} ] \qquad Equ . 3$$

The matrix inverse is computationally intensive, but it can be performed off line. Equation 3 gives us the tool to separate R,G, and B samples in a single sensor system, but there is much more we can do with this matrix. In the extreme case, we can set all the k values which are not on the diagonal to zero. This would mean we are measuring a single color per measurement. The problem with this is the aforementioned screen “blink”.

To eliminate the screen blink problem, exemplary systems/methods of the present disclosure utilize a mechanism called Temporally Based Intelligent Dither. This process allows the screen variation to occur for the necessary measurement, but utilizes precalculated gain combinations to minimize the appearance of change. This is done by introducing changes to the white point in a rapid manner that visually integrate to the same white point. If we assume that the matrix values can exceed 1.0 in value, it is possible to pre-calculate a set of color adjustments which introduce offsetting errors that temporally average to the correct white point while still providing enough excursion in signal level to make a low noise measurement.

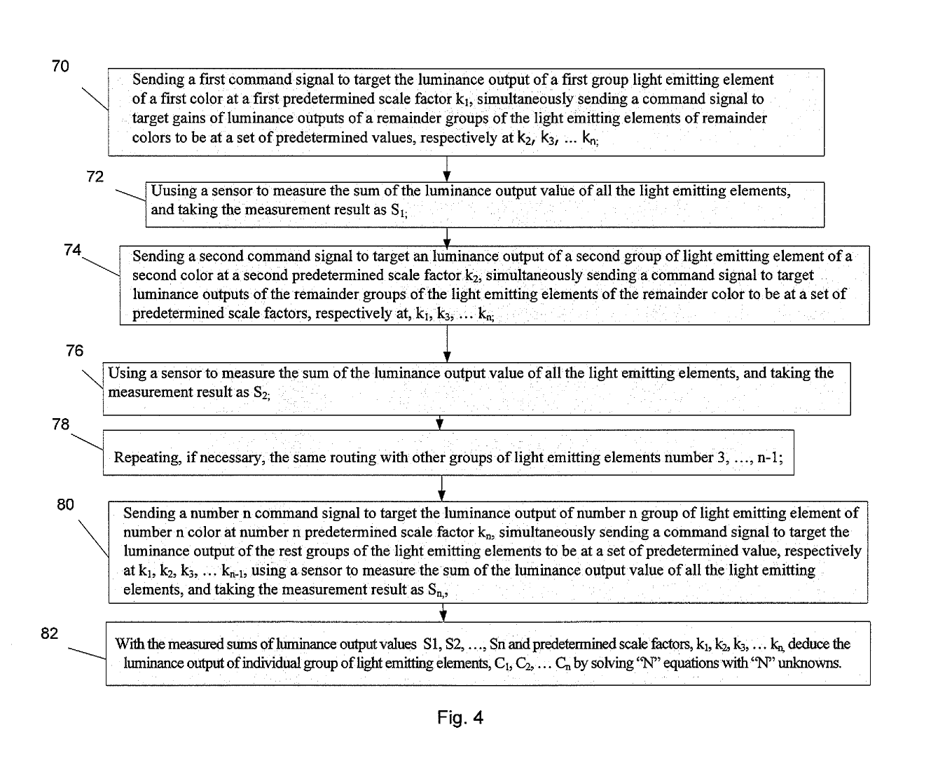

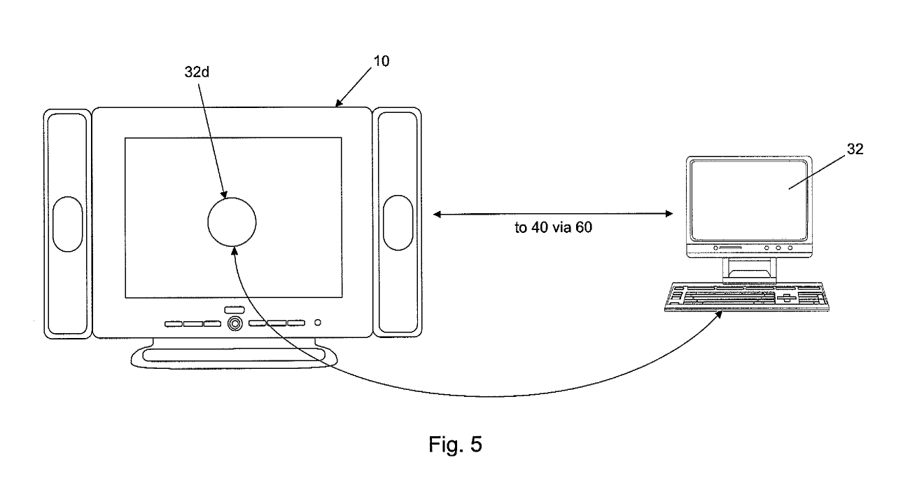

FIG. 4 shows that dither sampling and temporal dither sampling can be farther described in the steps as follows. For the purpose of providing a more generic description, it is assumed that we have a backlight controlling method and system for optimizing the control a backlight panel of an electronic display with N groups of light emitting elements emitting light of N colors.

a. sending 70 a first command signal to target the luminance output of a first group light emitting element of a first color at a first predetermined scale factor k₁, simultaneously sending a command signal to target gains of luminance outputs of a remainder of groups of the light emitting elements of remainder colors to be at a set of predetermined values, respectively at k₂, k₃, . . . kₙ;

b. using 72 a sensor to measure the sum of the luminance output value of all the light emitting elements, and taking the measurement result as S₁;

c. sending 74 a second command signal to target an luminance output of a second group of light emitting elements of a second color at a second predetermined scale factor k₂, simultaneously sending a command signal to target luminance outputs of the remainder groups of the light emitting elements of the remainder color to be at a set of predetermined scale factors, respectively at, k₁, k₃, . . . kₙ;

d. using 76 a sensor to measure the sum of the luminance output value of all the light emitting elements, and taking the measurement result as S₂;

e. repeating, 78 if necessary, the same routing with other groups of light emitting elements number 3, . . . , n-1;

f. sending 80 a number n command signal to target the luminance output of number n group of light emitting element of number n color at number n predetermined scale factor kₙ, simultaneously sending a command signal to target the luminance output of the rest of the groups of the light emitting elements to be at a set of predetermined value, respectively at k₁, k₂, k₃, . . . kₙ₋₁, using a sensor to measure the sum of the luminance output value of all the light emitting elements, and taking the measurement result as Sₙ,

g. repeating, if necessary, the same routing demonstrated by step a) and b) on previously measured group of light emitting elements but with different predetermined scale factor k, until j number of measurements are performed;

h. with the measured sums of luminance output values S1, S2, . . . , Sn and predetermined scale factors, k₁, k₂, k₃, . . . kₙ deduce 82 the luminance output of individual group of light emitting elements, C₁, C₂, . . . Cₙ by solving “N” equations with “N” unknown.

In another embodiment of this invention, each cycle of the above steps of a)-h) can be carried out at a very high frequency such that during any one cycle of the dither sampling measuring, the change in the luminance output of the electronic display can not normally be detected by human eyes. This process is called “temporal dither sampling measurement”.

a. A Factory Calibration Process

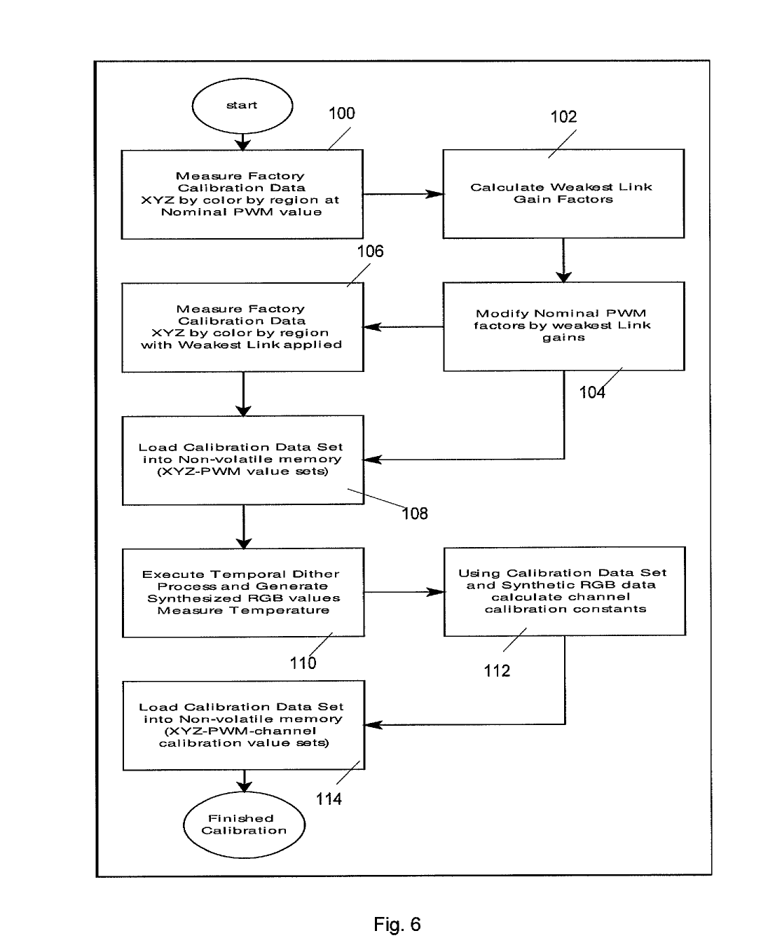

A factory calibration process is shown in FIG. 5. Tis process utilizes an external calorimeter 32d to measure data from display panel (10), and data collection system (32) to collect the color data 32d (illustrated diagrammatically) from multiple regions of display 10. The external calorimeter 32d is the standard that is used to calibrate the optical sensors 28. The calorimeter data 32d can then be fed back to the microprocessors controlling the display 10, processed and/or stored for later use, as described below. Another potential process is to use a calibrated camera to image the display and calculate the appropriate color coordinates for each region 26. This system is referred to as the CDCS (Colorimetric Data Collection System). A related process is shown in FIG. 6. If this calibration is performed when the backlight 22 is attached to the LCD panel 20, the panel 20 is set to display a full white signal. This procedure assumes an RGB emitter backlight, but it is extensible to other colors as well.

Step 1. The backlight control system is commanded to set all the PWM to a nominal setting. In nominal practice, this setting will be somewhere between 60 and 75% of full scale. This is based on the fact that as the display ages, it gets dimmer. This process provides “headroom” to allow correction for constant luminance as the display ages. Luminance is then measured 100 by color, by region.

Step 2: The CDCS is used to capture the color data. The data from the CDCS is analyzed to determine the weakest region in luminous intensity.

Step 3: A set of scale factors is calculated 102 and applied to the nominal PWM settings to reduce the luminous intensity of all LEDs to that of the region having the weakest luminous intensity. This will be referred to as the WLCN state (Weak Link Corrected Nominal) State.

Step 4. The backlight controller 104 is commanded to set the PW values to the WLCN state.

Step 5: The CDCS is used to capture the color luminance information 106 while in WLCN and colorimetric and the WLCN PWM data is stored 108 into non-volatile memory in the format of X, Y, Z.

Step 6: The temporal dither process is executed 110 and the display colors are measured by Cutter color and region 26. The luminance output of the temporal dither process is a set of synthetic RG,B values as calculated using the relationship described below.

Step 7: Use the XYZ measured in step 5 and the RGB data measured in step 6 to calculate 112 an RGB to XYZ conversion matrix and the inverse for each emitter region.

Step 8: Store 114 matrix data for each region into non volatile memory.

At the end of this process the following data is stored in nonvolatile memory by region:

XYZ data for each color emitter (9 values)

RGB synthesized data for each region (3 values)

PWM values for each emitter (3 values)

Temperature value at time of measurement (1 value)

RGB to XYZ matrix (9 values)

XYZ to RGB matrix (9 values)

The above represents the factory calibration data set.

The XYZ data for each region is represented in the 3×3 matrix. The PWM gain terms are represented by Gr_{xy}, Gg_{xy}, and Gb_{xy} terms. These are the required values to set the display to production whitepoint Xw Yw Zw as measured in CIE XYZ values. The RGB to XYZ conversion matrix in Step 7 is described by the following relationship:

$$[ \begin{matrix}Xw \\ Yw \\ Zw\end{matrix} ] = [ \begin{matrix}{Xr}_{xy} & {Xg}_{xy} & {Xb}_{xy} \\ {Yr}_{xy} & {Yg}_{xy} & {Yb}_{xy} \\ {Zr}_{xy} & {Zg}_{xy} & {Zb}_{xy}\end{matrix} ] * [ \begin{matrix}{Gr}_{xy} \\ {Gg}_{xy} \\ {Gb}_{xy}\end{matrix} ] \qquad Equ . 4$$

The XYZ to RGB matrix is simply the inverse of the 3×3 matrix in equation 1. To solve for an equivalent gain setting for an absolute white point we use the following equation:

$$[ \begin{matrix}{kr}_{xy} \\ {kg}_{xy} \\ {kb}_{xy}\end{matrix} ] = {[ \begin{matrix}{Xr}_{xy} & {Xg}_{xy} & {Xb}_{xy} \\ {Yr}_{xy} & {Yg}_{xy} & {Yb}_{xy} \\ {Zr}_{xy} & {Zg}_{xy} & {Zb}_{xy}\end{matrix} ]}^{- 1} * [ \begin{matrix}{X}^{†} w \\ {Y}^{†} w \\ {Z}^{†} w\end{matrix} ] \qquad Equ .. 5$$

Equation 5 describes the mechanism used to arrive at a new set of multipliers for a different white point setting from the native setting in the display. These multipliers are applied to initial gain terms to yield a new white point.

$$[ \begin{matrix}{X}^{†} w \\ {Y}^{†} w \\ {Z}^{†} w\end{matrix} ] = [ \begin{matrix}{Xr}_{xy} & {Xg}_{xy} & {Xb}_{xy} \\ {Yr}_{xy} & {Yg}_{xy} & {Yb}_{xy} \\ {Zr}_{xy} & {Zg}_{xy} & {Zb}_{xy}\end{matrix} ] * [ \begin{matrix}{kr}_{xy} * {Gr}_{xy} \\ {kg}_{xy} * {Gg}_{xy} \\ {kb}_{xy} * {Gb}_{xy}\end{matrix} ] \qquad Equ . 6$$

The synthesized R,G and B values based upon the optical analog measurement at calibration time are also stored during calibration. These are labeled as R_{cal}, G_{cal}, and B_{cal}.,

b. Base Gain Determination

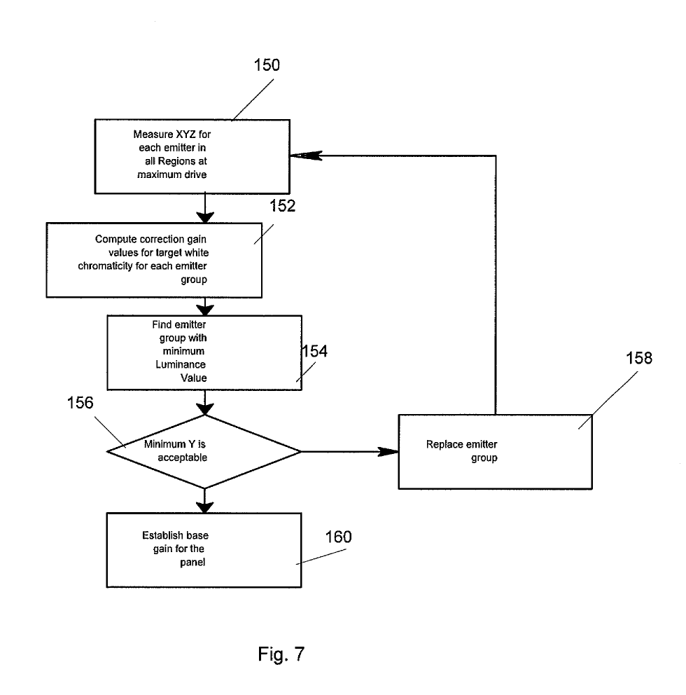

FIG. 7 shows a procedure of Base Gain Determination used to achieve the control of multiple regions through the management to the weakest region.

In FIG. 7, the presently disclosed backlight control system controls multiple regions 26 and thus must map all regions to a single specified white point. This requires that the mapping and correction algorithm must take into account 150 the range of operation of all regions of the blacklight 22 and then compute 152 a set of corrections to be used to set all regions to a specified point. The emitter group with the minimum luminance value is identified 154. If the minimum luminance value is not acceptable 156, the emitter group must be replaced 158. If the maximum attainable luminance of a specific region is lower than the desired luminance of the panel, all the other regions must be corrected to match the lowest region. This is establishing the base gain 160 for the panel. Management to the “weakest region” increases the effective lifetime of the display panel 20 because it tends to lower the power requirements of the rest of the panel regions. For maintenance purposes, the statistics of the light luminance output of each region of the panel are statistically monitored to predictively set the panel white point during the panel start up phase. This can be illustrated by the following equation.

$$[ \begin{matrix}{Gr}_{xy} \\ {Gg}_{xy} \\ {Gb}_{xy}\end{matrix} ] = {[ \begin{matrix}{Xr}_{xy} & {Xg}_{xy} & {Xb}_{xy} \\ {Yr}_{xy} & {Yg}_{xy} & {Yb}_{xy} \\ {Zr}_{xy} & {Zg}_{xy} & {Zb}_{xy}\end{matrix} ]}^{- 1} * [ \begin{matrix}C * Xw \\ C * Yw \\ C * Zw\end{matrix} ] \qquad Equ . 7$$

Where Gr_{xy} represents the gain applied to the red emitter at location xy. The “C” term is a statistically determined factor that accounts for the maximum achievable luminance of the minimum performing region 26. We term this the base gain factor. During the course of the manufacturing process the measured Tristimulus values XYZ of each color region are tabulated and stored into a programmable memory element. The data is analyzed and the system gain is set based upon the analysis of the weakest region.

c. An Automatic Calibration Process

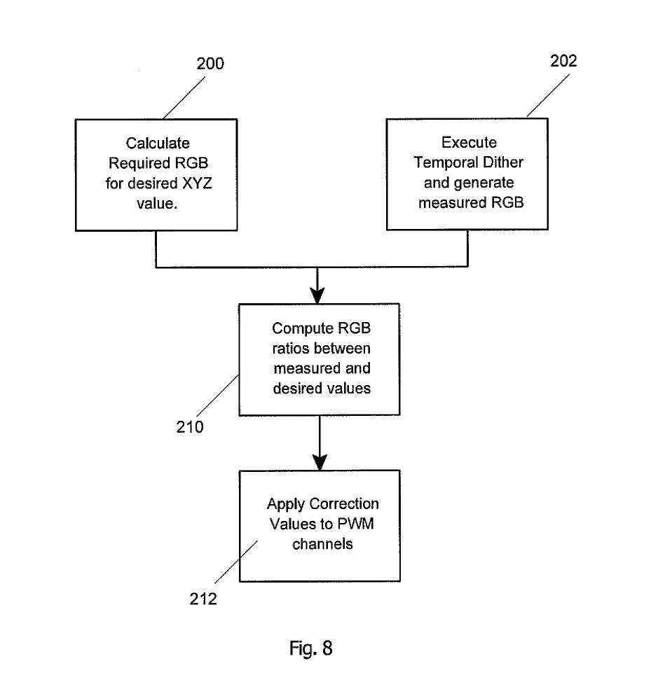

FIG. 8 shows an automatic field calibration process which takes place when a display system is in a user environment. The automatic field calibration process is used to change the display luminance. The input to this process is the desired absolute Tristimulus XYZ value of the display. The steps of this process are explained below.

Step 1: Calculate 200 the desired RGB value using the XYZ to RGB matrix determined in the factory according to:

$$[ \begin{matrix}{kr}_{xy} \\ {kg}_{xy} \\ {kb}_{xy}\end{matrix} ] = {[ \begin{matrix}{Xr}_{xy} & {Xg}_{xy} & {Xb}_{xy} \\ {Yr}_{xy} & {Yg}_{xy} & {Yb}_{xy} \\ {Zr}_{xy} & {Zg}_{xy} & {Zb}_{xy}\end{matrix} ]}^{- 1} * [ \begin{matrix}{X}^{†} w \\ {Y}^{†} w \\ {Z}^{†} w\end{matrix} ] \qquad Equ . 8$$

Step 2: Simultaneously with Step 1, execute the Temporal Dither/Capture process 202 and generate the measured RGB values for the given region. These are labeled as Rₘ, Gₙ, and Bₘ₁.

Step 3: Compute 210 the RGB ratios between the current setting and the desired RGB values taking into account the scale factor computed 200 in step 1.

R_{correction}=(kr_{xy}*R_{ca1})/Rₘ

G_{correction}=(kg_{xy}*G_{ca1})/Gₘ

B_{correction}=(kb_{xy}*B_{ca1})/Bₘ

Step 4: Apply 212 correction values to PWM channel values.

R_PWMvalue=Gr*R_{correction}

G_PWMvalue=Gg*G_{correction}

B_PWMvalue=Gb*B_{correction}

This process is repeated for each region.

d. Choosing the Constants for Change

One goal of the Temporarily Based Dither process is to provide a measurement by introducing changes into the input PWM controller for a particular color in a region and measuring the resultant optical output in the sensor used to monitor the region. If large random changes are made in the signal, it is highly likely that these will be observable in the long term in the output color of the display. The goal is to minimize the observable difference while still arriving at a useful measurement of signal level. This is accomplished by actively changing the display colors in a pre-calculated fashion at speeds greater than 1/60 hz.

Judicious choice of the dither values can dramatically reduce any visual artifacts of the Dither process. Equation 7 is valid for any physically realizable values of the “t” values but an intelligent pre-selection based upon the visual response of the eye can be used to determine the required elements of Equation 7.

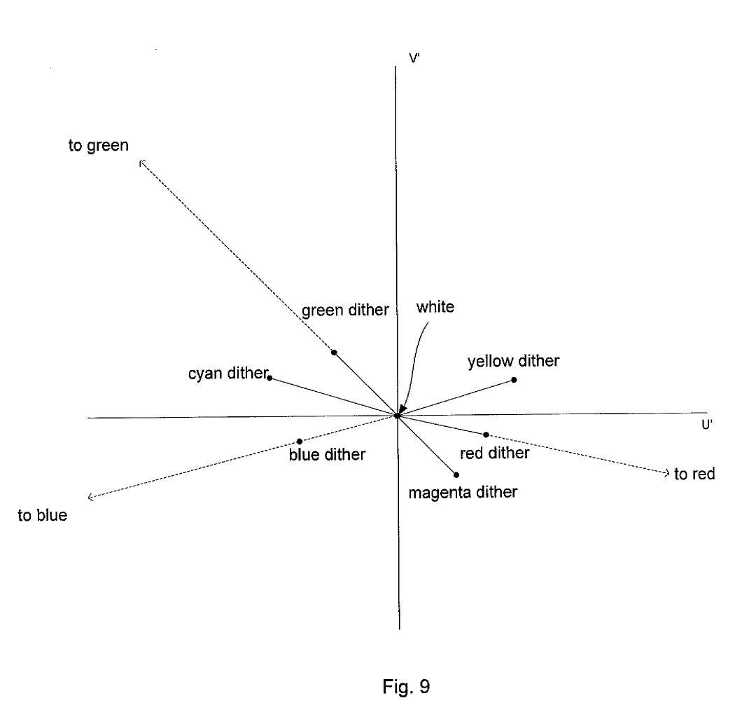

Referring now to FIG. 9 we see an illustration of a representation of the dither process using CIE u′v′ color space to make the selection of the gain variables.

The center of FIG. 9 represents the white point of the display on a u′v′ plot. For a Color Temperature of D65 this would represent .1978, .4693. The dotted lines represent straight lines drawn to the respective Red, Green and Blue, primaries of the display. The u′v′ diagram is used because equal distances in this space generally represent equal visual differences. As illustrated on the figure, changes can be made that are visually equal and opposite. For instance, an increase in the blue gain will “push” the white towards the blue primary. An increase in the Red and Green Gain will “pull” the white towards a yellowish hue. Similarly, an increase in Green will cause the screen to move towards the green, but an increase of Red and Blue will cause the screen to move towards the magenta. The selection process involves computing the gains for an equal but opposite vector for a gain change in the direction of each primary. Rapid changes in colors with these constraints will appear to be nominally the same as the white from which they were derived. The primaries of the display are determined during the calibration process as are the values of the nominal white point. From this data, the dither constants are derived using the following procedure.

Step 1. Based upon a given vector length in u′v′ space, calculate the u′v′ coordinates of the vectors described by the primaries and the “anti-primaries” (a vector of equal magnitude, but opposite direction).

Step 2. Convert the u′v′ data to XYZ values using the standard CIE conversion equations well known in the literature. Assume a value of luminance equal to the value for the white point at the time of factory calibration.

Step 3. Multiply the XYZ values by the XYZ to RGB matrix determined in the calibration process.

Step 4. These values are now the scale factors used in the dither process.

Although the present disclosure has been described with reference to exemplary embodiments and exemplary implementations thereof, the present disclosure is not limited to or by such exemplary embodiments/implementations. Rather, the present disclosure is subject to many changes, modifications and/or enhancements without departing from the spirit or scope hereof. Accordingly, the present disclosure expressly encompasses all such changes, modifications and/or enhancements.

1. An electronic display with a backlight control system, a display panel, a backlight panel with one or multiple regions with each region having N groups of light emitting elements of N colors, comprising:
at least one monochromatic sensor for each said region;
a colorimetric processing engine which provides optimization in controlling the backlight panel by utilizing dither sampling measuring in obtaining feedback from said at least one monochromatic sensor.

2. The electronic display of claim 1, wherein the dither sampling measuring includes the steps of:
a) sending a first command signal to target a luminance output of a first group of light emitting elements of a first color at a first predetermined scale factor k₁, simultaneously sending a command signal to target gains of luminance outputs of a remainder of groups of the light emitting elements of a remainder of colors to be at a set of predetermined values, respectively at k₂, k₃, . . . kₙ,;
b) using a sensor to measure the sum of the luminance output value of all the light emitting elements, and taking the measurement result as S₁;
c) sending a second command signal to target a luminance output of a second group of light emitting elements of a second color at a second predetermined scale factor k₂, simultaneously sending a command signal to target luminance outputs of a remainder of groups of the light emitting elements of a remainder color to be at a set of predetermined scale factors, respectively at, k1, k3, . . . kn;
d) using a sensor to measure the sum of the luminance output value of all the light emitting elements, and taking the measurement result as S₂;
e) repeating, if necessary, steps (a) through (d) with other groups of light emitting elements number 3, . . . , n-1;
f) sending a number n command signal to target the luminance output of number n group of light emitting elements of number n color at number n predetermined scale factor kₙ, simultaneously sending a command signal to target the luminance output of the rest of the groups of light emitting elements to be set at a predetermined value, respectively at k₁, k₂, k₃, . . . kₙ₋₁, using a sensor to measure the sum of the luminance output value of all the light emitting elements, and taking the measurement result as Sₙ,
g) repeating, if necessary, steps a) and b) on a previously measured group of light emitting elements but with different predetermined scale factor k, until j number of measurements are performed;
h) with the measured sums of luminance output values S₁, S₂ . . . , Sₙ and predetermined scale factors, k₁, k₂, k₃, . . . kₙ, deduce the luminance output of individual group of light emitting elements, C₁, C₂, . . . Cₙ by solving “N” equations with “N” unknowns.

3. The electronic display of claim 2, wherein said backlight panel of said electronic display can be factory calibrated by:
a) grouping the light emitting elements into a plurality of regions;
b) measuring CIE XYZ Tristimulus values at the plurality of regions of the display panel;
c) identifying the region with the lowest luminance output;
d) calculating correction scale factors to normalize the luminance output among all regions;
e) downloading and storing of the constants to enable standalone calibration when the electronic display is used outside of the factory,
f) executing the dither sampling measuring method in steps (a)-(h) of claim 2;
g) calculating appropriate correction scale factors to the luminance output level supplied to the light emitting elements based upon the deduced luminance output of the light emitting elements from the dither sampling measuring.

4. The electronic display of claim 2, wherein the backlight panel can be automatically calibrated in the field by:
a) executing the dither sampling measuring method and deducing a current luminance output for each group of light emitting elements;
b) computing a new scale factor for each color by computing the ratio of the factory calibrated level and the current luminance output level for the color;
c) multiplying the scale factor by a current Pulse Width Modulation scale factor for the color.

5. A backlight control system for electronic displays having a display panel; a backlight panel with one or multiple regions with each region having N groups of light emitting elements of N colors; comprising:
at least one monochromatic sensor for each said region;
a colorimetric processing engine;
wherein said colorimetric processing engine provides optimization in controlling the backlight panel by utilizing temporal dither sampling measuring in obtaining the feedback from the backlight monochromatic sensors.

6. The backlight control system of claim 5, wherein the temporal dither sampling measuring includes the steps of:
a) sending a first command signal to target a luminance output of a first group of light emitting elements of a first color at a first predetermined scale factor k₁, simultaneously sending a command signal to target gains of luminance outputs of a remainder of groups of the light emitting elements of a remainder of colors to be at a set of predetermined values, respectively at k₂, k₃, . . . kₙ;
b) using a sensor to measure the sum of the luminance output value of all the light emitting elements, and taking the measurement result as S₁;
c) sending a second command signal to target a luminance output of a second group of light emitting element of a second color at a second predetermined scale factor k₂, simultaneously sending a command signal to target luminance outputs of a remainder of groups of the light emitting elements of a remainder color to be at a set of predetermined scale factors, respectively at, k1, k3, . . . kn;
d) using a sensor to measure the sum of the luminance output value of all the light emitting elements, and taking the measurement result as S₂;
e) repeating, if necessary, the same routing with other groups of light emitting elements number 3, . . . , n-1;
f) sending a number n command signal to target the luminance output of number n group of light emitting element of number n color at number n predetermined scale factor kₙ, simultaneously sending a command signal to target the luminance output of the rest of the groups of light emitting elements to be at a set of predetermined values, respectively at k₁, k₂, k₃, . . . kₙ₋₁ using a sensor to measure the sum of the luminance output value of all the light emitting elements, and taking the measurement result as Sₙ;
g) repeating, if necessary, steps a) and b) on previously measured group of light emitting elements but with different predetermined scale factor k, until j number of measurements are performed;
h) with the measured sums of luminance output values S₁, S₂, . . . , Sₙ and predetermined scale factors, k₁, k₂, k₃, . . . kₙ, deduce the luminance output of individual group of light emitting elements, C₁, C₂, . . . Cₙ by solving “N” equations with “N” unknowns, each cycle of steps of a) to h) being carried out at a frequency such that during any one cycle of temporal dither sampling measuring, the change in the luminance output of the electronic display can not normally be detected by human eyes.

7. The backlight control system of claim 6, wherein said backlight panel can be factory calibrated by:
a) grouping and separating the backlight panel into at least one region;
b) measuring CIE XYZ Tristimulus values at a plurality of regions of the display panel;
c) identifying the region with the lowest luminance output;
d) calculating correction scale factors to normalize the luminance output among all regions;
e) downloading and storing of the constants to enable standalone calibration when the electronic display is used outside of the factory;
f) executing the temporal dither sampling measuring in steps (a)-(h) of claim 6;
g) calculating appropriate correction scale factors to the luminance output level supplied to the light emitting elements based upon the deduced luminance output of the light emitting elements from the dither sampling measuring;
h) concatenating scale factors from steps (d) and (g) and applying the result to pulse width modulation signal levels.

8. The backlight control system of claim 6, wherein the backlight control of the backlight panel can be automatically calibrated in the field by:
a) executing temporal dither sampling measuring and deducing a current luminance output for each group of light emitting elements;
b) computing a new scale factor for each color by computing the ratio of a factory calibrated level for said color and the current luminance output level for said color;
c) multiplying said scale factor to the current Pulse Width Modulation scale factor for said color.

9. A method for controlling a backlight panel of an electronic display with N groups of light emitting elements emitting light of N colors, comprising steps of:
a) conducting dither sampling measuring to measure the luminance output of the N groups of light emitting elements emitting light of N colors in response to predetermined command signals;
b) using at least one monochromatic sensor to measure the luminance output of the light emitting element;
c) pre-calculating individual luminance output of each group of light emitting elements of the backlight.

10. The method of claim 9, farther comprising the steps of:
a) sending a first command signal to target a luminance output of a first group light emitting element of a first color at a first predetermined scale factor k₁, simultaneously sending a command signal to target gains of luminance outputs of a remainder groups of the light emitting elements of remainder colors to be at a set of predetermined values, respectively at k₂, k₃, . . . kₙ;
b) using a sensor to measure the sum of the luminance output value of all the light emitting elements, and taking the measurement result as S₁;
c) sending a second command signal to target a luminance output of a second group of light emitting element of a second color at a second predetermined scale factor k₂, simultaneously sending a command signal to target luminance outputs of the remainder groups of the light emitting elements of the remainder color to be at a set of predetermined scale factors, respectively at, k₁, k₃, . . . kₙ;
d) using a sensor to measure the sum of the luminance output value of all the light emitting elements, and taking the measurement result as S₂;
e) repeating, if necessary, the same routing with other groups of light emitting elements number 3, . . . , n-1;
f) sending a number n command signal to target the luminance output of number n group of light emitting element of number n color at number n predetermined scale factor kₐ, simultaneously sending a command signal to target the luminance output of the rest of the groups of the light emitting elements to be at a set of predetermined value, respectively at k₁, k₂, k₃, . . . kₙ₋₁, using a sensor to measure the sum of the luminance output value of all the light emitting elements, and taking the measurement result as Sₙ,
g) repeating, if necessary, steps a) and b) on previously measured group of light emitting elements but with different predetermined scale factor k, until j number of measurements are performed,
h) with the measured sums of luminance output values S₁, S₂, . . . , Sₙ and predetermined scale factors, k₁, k₂, k₃, . . . kₙ, deduce the luminance output of individual group of light emitting elements, C₁, C₂, . . . Cₙ by solving “N” equations with “N” unknowns.

11. The method of claim 10, wherein said dither sampling method can be used in combination with the following steps for a factory calibration of the backlight control of the backlight panel, further comprising the steps of:
a) grouping and separating the backlight panel into at least one region;
b) measuring CIE XYZ Tristimulus values at a plurality of regions of the display panel;
c) identifying the region with the lowest luminance output;
d) calculating correction scale factors to normalize the luminance output among all regions;
e) downloading and storing of the constants to enable standalone calibration when the electronic display is used outside of the factory;
f) executing the dither sampling measuring method in steps (a)-(h) of claim 10;
g) calculating appropriate correction scale factors to the luminance output level supplied to the light emitting elements based upon the deduced luminance output of the light emitting elements from said dither sampling measuring method.

12. The method of claim 10, wherein said dither sampling method can be used in combination with the following steps for an automatic field calibration of the backlight control of the backlight panel further comprising the steps of:
a) executing said dither sampling measuring method and deducing the current luminance output for each group of light emitting elements;
b) computing the new scale factor for each color by computing the ratio of the factory calibrated level for said color and the current luminance output level for said color;
c) multiplying said scale factor to the current Pulse Width Modulation scale factor for said color.

13. A backlight controlling method for optimizing the control of a backlight panel of an electronic display with N groups of light emitting elements emitting light of N colors, comprising the steps of:
a) effectuating a temporal dither sampling measuring method to measure the luminance output of the N groups of light emitting elements emitting light of N colors in response to predetermined command signals;
b) using at least one monochromatic sensor to measure the luminance output of the light emitting element;
c) pre-calculating individual luminance output of each group of light emitting elements of the backlight;
wherein said temporal dither sampling measuring method is carried out at a very high frequency such that during any one cycle of the temporal dither sampling measuring step, the change in the luminance output of the electronic display can not normally be detected by human eyes.

14. The method of claim 13, further comprising steps of:
a) sending a first command signal to target an luminance output of a first group light emitting element of a first color at a first predetermined scale factor k₁, simultaneously sending a command signal to target gains of luminance outputs of a remainder groups of the light emitting elements of remainder colors to be at a set of predetermined values, respectively at k₂, k₃, . . . kₙ;
b) using a sensor to measure the sum of the luminance output value of all the light emitting elements, and taking the measurement result as S₁;
c) sending a second command signal to target an luminance output of a second group of light emitting element of a second color at a second predetermined scale factor k₂, simultaneously sending a command signal to target luminance outputs of the remainder groups of the light emitting elements of the remainder color to be at a set of predetermined scale factors, respectively at, k1, k3, . . . kn;
d) using a sensor to measure the sum of the luminance output value of all the light emitting elements, and taking the measurement result as S₂;
e) repeating, if necessary, the same routing with other groups of light emitting elements number 3, . . . , n-1;
f) sending a number n command signal to target the luminance output of number n group of light emitting element of number n color at number n predetermined scale factor kₙ, simultaneously sending a command signal to target the luminance output of the rest groups of the light emitting elements to be at a set of predetermined value, respectively at k₁, k₂, k₃, . . . kₙ₋₁, using a sensor to measure the sum of the luminance output value of all the light emitting elements, and taking the measurement result as Sₙ,
g) repeating, if necessary, the same routing demonstrated by step a) and b) on previously measured group of light emitting elements but with different predetermined scale factor k, until j number of measurements are performed;
h) with the measured sums of luminance output values S₁, S₂, . . . , Sₙ and predetermined scale factors, k₁, k₂, k₃, . . . kₙ, deduce the luminance output of individual group of light emitting elements, C₁, C₂, . . . Cₙ by solving “N” equations with “N” unknowns.

15. The method of claim 14, wherein said temporal dither sampling method can be used in combination with the following steps for a factory calibration of the backlight control of the backlight panel further comprising the steps of:
a) grouping and separating the backlight panel into at least one region;
b) measuring CIE XYZ Tristimulus values at plurality of regions of the display panel;
c) identifying the region with the lowest luminance output;
d) calculating correction scale factors to normalize the luminance output among all regions;
e) downloading and storing of the constants to enable standalone calibration when the electronic display is used outside of the factory;
f) executing the temporal dither sampling measuring method in steps (a)-(h) of claim 14;
g) calculating appropriate correction scale factors to the luminance output level supplied to the light emitting elements based upon the deduced luminance output of the light emitting elements from said dither sampling measuring method.

16. The method of claim 14, wherein said dither sampling method can be used in combination with the following steps for an automatic field calibration of the backlight control of the backlight panel further comprising the steps of:
a) executing said temporal dither sampling measuring method and deducing the current luminance output for each group of light emitting elements;
b) computing the new scale factor for each color by computing the ratio of the factory calibrated level for said color and the current luminance output level for said color;
c) multiplying said scale factor to the current Pulse Width Modulation scale factor for said color.

17. A method for measuring the luminance output of a plurality of light emitting elements for emitting light of a plurality of different colors, comprising the steps of:
(a) providing a monochromatic sensor capable of measuring luminance output of a plurality of different color light emitting elements;
(b) determining a first input signal level having a first predetermined magnitude k₁;
(c) applying the first input signal level to a first of the plurality of light emitting elements of a first color and measuring an associated first luminance output L₁ with the sensor;
(d) determining a second input signal level having a second predetermined magnitude k₂;
(e) applying the second input signal level to a second of the plurality of light emitting elements of a second color and measuring an associated second luminance output L₂ with the sensor.
(f) deducing the luminance output for each of the first and second light emitting elements based upon k₁, k₂, L₁, L₂.

18. The method of claim 17, wherein k₁=k₂ and steps (C) and (E) are conducted sequentially.

19. The method of claim 17, wherein steps (C) and (E) are conducted simultaneously a plurality of times with k₁ and k₂ varying each time and generating associated combined luminance outputs LC₁, . . . , LC_{f}, where f≧2.

20. The method of claim 19, wherein the rate of repeating steps (C) and (E) exceeds that visually perceptible by humans.

21. The method of claim 19, wherein k1 and k2 are selected on each repetition of steps (C) and (E) to diminish color change exhibited by the combined illumination of the first and second light emitting elements to make the steps less perceptible.

22. The method of claim 19, further comprising the steps (A0) of ascertaining a criteria set of luminance outputs for the plurality of light emitting elements prior to step (A), and (G) adjusting the input signal level of the plurality of light emitting elements to achieve the criteria set when the measured luminance output differs from the criteria set.

23. The method of claim 22, wherein said steps (A)-(G) are conducted while a display of which the light emitting elements are a part is in use.
